(19) United States
(12) Patent Application Publication
(10) Pub. No.: US 2004/0022505 A1
(43) Pub. Date: Feb. 5, 2004

(54) Optical fiber drop cable

(76) Inventors: Bernard Raymond Eichenbaum, Basking Ridge, NJ (US); Terry Don Mathis, Lilburn, GA (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/208,659

(22) Filed: Jul. 30, 2002

(51) Int. Cl. G02B 6/44

(52) U.S. Cl. 385/114

(57) ABSTRACT

An optical fiber drop cable for carrying one or more optical fibers from a curb to a customer premises. The optical fiber drop cable comprises first and second ribbon-like longitudinal support members disposed one atop the other and having one or more optical fibers disposed between them in a longitudinal direction of the first and second ribbon-like longitudinal support members. The first and second ribbon-like longitudinal support members each have first and second edges and inner and outer surfaces. The first edge of the first ribbon-like longitudinal support member is secured to the first edge of the second ribbon-like longitudinal support member and the second edge of the first ribbon-like longitudinal support member is secured to the second edge of the second ribbon-like longitudinal support member. Securing the edges of the first and second ribbon-like members together in this manner obviates the need to extrude an outer jacket for the cable, which decreases manufacturing costs, thereby decreasing the overall cost of the optical fiber drop cable.

### TECHNICAL FIELD OF THE INVENTION

The present invention is generally related to communications and, more particularly, to an optical fiber cable for use as a drop cable for carrying optical fibers from the curb to the customer premises.

### BACKGROUND OF THE INVENTION

Drop cables are cables that run from the curb to the customer premises and typically carry either telephone signals (twisted copper pairs), cable television signals (coaxial cables) or computer data. Drop cables are connected to a pedestal at the curb and to a network interface unit at the customer's home. In the near future, it is expected that a demand will exist for a very low cost optical fiber cable containing generally 2-4 optical fibers, but possibly up to 12 fibers, that is suitable for use as a drop cable. The fibers may be bare fibers, buffered fibers or ribbon fibers. Optical fibers have a much broader bandwidth than twisted copper pair and coaxial cables, and thus enable additional services, such as streaming video, to be provided to customers. For this reason, it is desirable to provide a “fiber-to-the-home” solution.

The lengths of drop cables are on the order of the typical distance from a curb to the side of a home. Optical fiber drop cables will have a use similar to that of the 75 ohm coaxial drop cables presently used in the Community Antenna Television (CATV) industry. In order for the widespread use of optical fiber drop cables to be feasible, certain constraints will need to be met. One of the primary constraints is cost. An optical fiber drop cable will need to be very low cost to manufacture in order for it to be a feasible fiber-to-the-home solution. Drop cables are often cut when they are buried underground by home owners using digging tools that are accidentally placed in contact with the drop cables. This type of damage to drop cables is typical. Consequently, an optical fiber drop cable will need to be inexpensive to replace in order for it to be an economically feasible solution.

Current optical fiber drop cables have relatively high tensile strengths, which increases the cost of the drop cable. However, regardless of tensile strength, most cutting tools that come in contact with a buried drop cable will cut through it. Also, known optical fiber drop cables have outer jackets that are extruded during the manufacturing process by an extrusion machine. The extrusion machine and extrusion process increase the cost of the manufacturing and therefore increase the cost of the optical fiber drop cable. Furthermore, optical fiber drop cables currently in use are manufactured to have considerable water proofing characteristics, which also increases the cost of the drop cable. However, because drop cables typically are buried only about six inches below the surface of the ground, water proofing is not critical. If the optical attenuation were to increase, the length of the drop cable is short enough that the increase in attenuation would be negligible.

Another constraint is that the end of an optical fiber drop cable should be relatively easy to open for connection purposes and relatively easy to mount on the side of a house or building. Otherwise, labor costs might make the use of an optical fiber drop cable economically unfeasible.

Accordingly, a need exists for an optical fiber cable that is suitable for use as a drop cable, that is relatively inexpensive to manufacture and that is relatively easy to connect and install, thereby minimizing the costs associated with the manufacture and usage of the optical fiber drop cable.

### SUMMARY OF THE INVENTION

The present invention provides an optical fiber drop cable that can be manufactured relatively inexpensively and that can be relatively easily connected and installed. The optical fiber drop cable comprises first and second ribbon-like longitudinal support members disposed one atop the other and having one or more optical fibers disposed between them in a longitudinal direction of the first and second ribbon-like longitudinal support members. The first and second ribbon-like longitudinal support members each have first and second edges and inner and outer surfaces. The first edge of the first ribbon-like longitudinal support member is secured to the first edge of the second ribbon-like longitudinal support member and the second edge of the first ribbon-like longitudinal support member is secured to the second edge of the second ribbon-like longitudinal support member.

Securing the edges of the first and second ribbon-like members together in this manner obviates the need to extrude an outer jacket for the cable, which decreases manufacturing costs, thereby decreasing the overall cost of the optical fiber drop cable.

The method of the present invention comprises the steps of securing one or more optical fibers between the first and second ribbon-like longitudinal support members disposed one atop the other, securing the first edge of the first ribbon-like longitudinal support member to the first edge of the second ribbon-like longitudinal support member and securing the second edge of the first ribbon-like longitudinal support member to the second edge of the second ribbon-like longitudinal support member.

The edges of the first and second ribbon-like longitudinal members can be secured together by a plurality of mechanisms such as, for example, glue bonding, heat bonding, ultrasonic bonding and solvent bonding. Because extrusion is not needed to form the outer jacket, the speed of manufacturing the drop cable can be increased and the size and complexity of the manufacturing line can be decreased.

These and other features and advantages will become apparent from the following description, drawings and claims.

### BRIEF DESCRIPTION OF THE DRAWINGS

FIG. 1 is a cross-sectional end view of the optical fiber drop cable of the present invention that illustrates the edges of the first and second ribbon-like members secured together.

FIG. 2 is an expanded cross-sectional end view of the drop cable of the present invention that shows the ribbon-like members and the rubber cushion members surrounding several optical fibers.

FIG. 3 is a block diagram of a manufacturing line that is suitable for manufacturing the optical fiber drop cable shown in FIGS. 1 and 2.

FIG. 4 is a flow chart illustrating the method of the present invention performed by the manufacturing line shown in FIG. 3.

FIGS. 5A and 5B illustrate a top view and a side view, respectively, of the ribbon-like support members of the present invention that are bonded together to form the outer jacket of the optical fiber drop cable.

### DETAILED DESCRIPTION OF THE PREFERRED EMBODIMENTS OF THE INVENTION

In accordance with the present invention, it has been determined that an optical fiber drop cable does not need to have high tensile strength. It has also been determined in accordance with the present invention that water proofing can be minimal for an optical fiber drop cable. All of these factors enable an optical fiber drop cable to be manufactured at very low cost. As stated above, high tensile strength does not prevent digging or cutting tools from cutting through the drop cables. Therefore, the costs associated with manufacturing an optical fiber drop cable to have high tensile strength can be foregone. As also indicated above, although current optical fiber drop cables are manufactured to have considerable water proofing qualities, water proofing can be minimal for an optical fiber drop cable. If a lack of considerable water proofing results in attenuation, due to the short length of the drop cable the attenuation will be negligible. Consequently, the optical fiber drop cable of the present invention preferably has minimal water proofing characteristics, which also reduces costs.

Another important feature of the present invention that enables the cost of the optical fiber drop cable to be reduced is that the optical fiber drop cable can be manufactured without using an extrusion machine and process, which greatly decreases manufacturing costs, as discussed below in more detail.

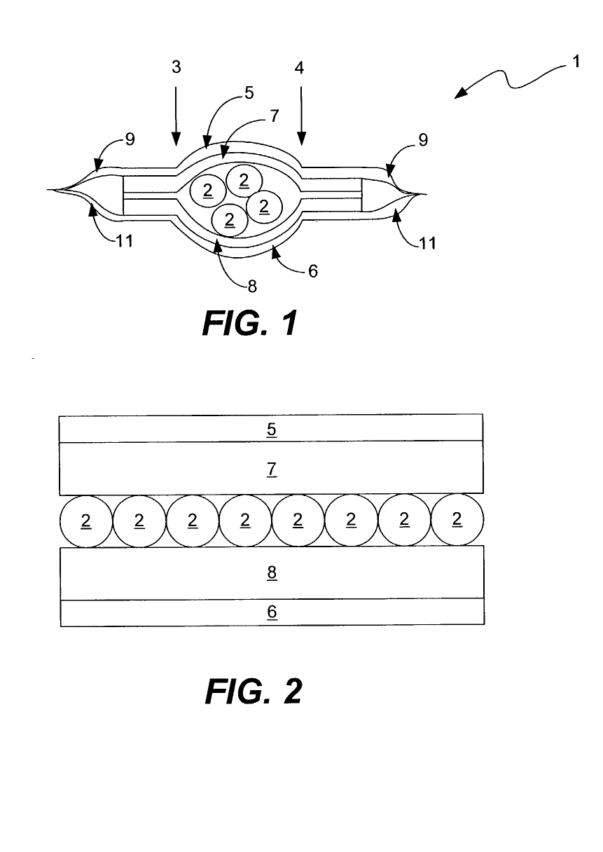

FIG. 1 is an end view of the optical fiber drop cable 1 of the present invention in accordance with an embodiment. In this embodiment, the drop cable 1 is shown as having four optical fibers 2 that are sealed within the sides 3 and 4 of the drop cable 1. The drop cable 1 of this embodiment comprises a top ribbon supporting member 5 and a bottom ribbon supporting member 6. These ribbon supporting members 5 and 6 form the outer jacket of the drop cable 1 when the edges of the members 5 and 6 are bonded together, as discussed below in more detail.

The drop cable 1 also comprises a rubber layer 7 adjacent the top ribbon supporting member 5 and a rubber layer 8 adjacent the lower ribbon supporting member 6. The rubber layers, or ribbons, 7 and 8 function as a cushion material that protects the optical fibers, which may be buffered or unbuffered. Rather than rubber, a gel could be used for this purpose. At the edges 3 and 4 of the drop cable 1, the rubber layers 7 and 8 are pushed together due to the force associated with the bonding together of the outer edges 9 and 11 of the top and bottom ribbon supporting members 5 and 6, respectively. The manner in which the drop cable is manufactured will be discussed below with reference to FIG. 3.

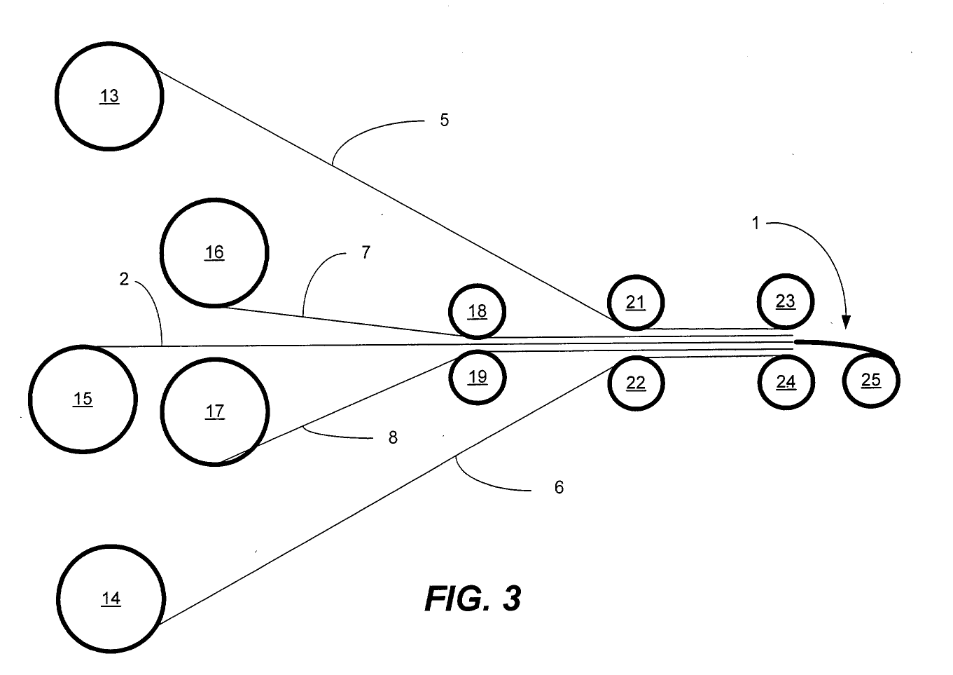

FIG. 2 is a cross-sectional view of the drop cable 1 of FIG. 1 before the outer edges of the top 5 and bottom 6 ribbon supporting members have been bonded together at the outer edges 9 and 11 (FIG. 1). In this embodiment, eight optical fibers are shown as being comprised by the drop cable 1. However, it should be noted that the number of optical fibers contained within the drop cable is not limited to any particular number. Also, although the rubber layers 7 and 8 are shown as being larger than the ribbon supporting members 5 and 6, this may or may not be the case and is not critical to the present invention. This difference in thickness in the drawings is merely shown to facilitate distinction between the rubber ribbons 7 and 8 (or rubber layers or rubber tape) and the strength supporting ribbon members 5 and 6. The ribbon supporting members 5 and 6 may be the same as or similar to the synthetic ribbons that are often used to in the packaging industry to secure boxes and box tops together for shipping. This type of ribbon is suitable for use as the ribbon supporting members of the present invention because it is very strong, has minimal elongation, is very inexpensive, and the edges of two such ribbons placed one atop the other can be easily bonded together.

The overall cost of the optical fiber drop cable of this embodiment is minimized due to the low cost of the ribbon material and the speed at which the edges of the top and bottom ribbon supporting members can be bonded together, which reduces manufacturing costs. The cost of manufacturing cables is determined in large part by how long the cable is on the manufacturing line. As stated above, it is not necessary to use an extrusion machine to bond the edges of the ribbon supporting members together. The rate of manufacture is simply dependent on the speed at which the edges of the top and bottom ribbon supporting members 5 and 6 can be bonded together, which is much faster than extruding plastic. Also, the length of the manufacturing line needed to manufacture the drop cable is relatively short because it only needs to be long enough to bring the ribbon support members 5 and 6, the optical fibers 2 and the rubber ribbons 7 and 8 together, which also reduces costs.

FIG. 3 is a block diagram of an embodiment of a manufacturing line that is suitable for manufacturing the optical fiber drop cable of the present invention. The manner in which the drop cable of the present invention is produced by the manufacturing line will now be described with reference to FIGS. 1, 2 and 3. The manufacturing line in accordance with this embodiment comprises two rolls 13 and 14 that carry the ribbon supporting material that corresponds to the top 5 and bottom 6 ribbon supporting members, one roll 15 that carries the optical fibers, and two rolls 16 and 17 that carry a rubber tape that corresponds to the top 7 and bottom 8 rubber layers.

A first bonder represented by the two rolls 18 and 19 secures the optical fibers 2 from roll 15 within the upper and lower rubber tape layers 7 and 8 from rolls 16 and 17. At this or an earlier stage in the manufacturing process, a water blocking powder or grease is applied to the optical fibers for water proofing. A second bonder represented by rolls 21 and 22 bonds the upper 7 and lower 8 rubber tape layers having the optical fibers between them within the upper and lower ribbon supporting members 5 and 6. A third bonder represented by rolls 23 and 24 then bonds the outer edges 9 and 11 of the ribbon supporting members 5 and 6 together. At this point, the formation of the drop cable 1 of the present invention is complete and it can then be taken up on a take up roll 25.

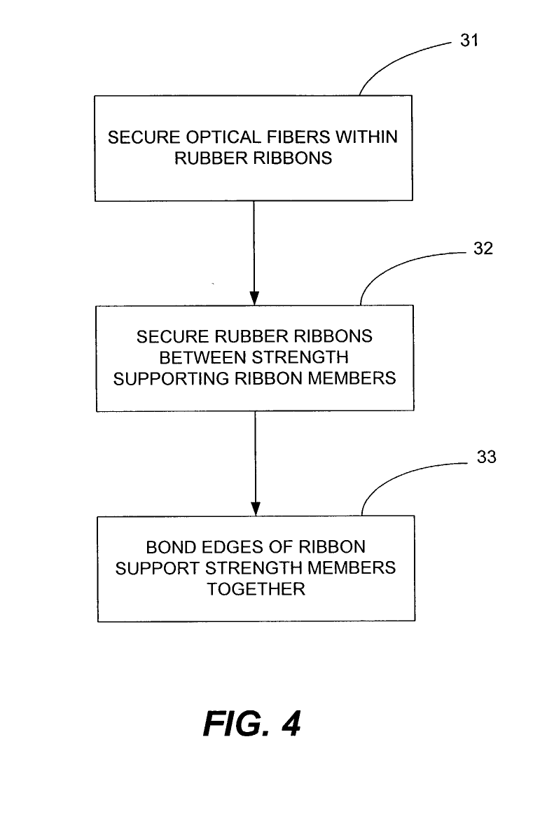

FIG. 4 is a flow chart representing the method of the present invention in accordance with an embodiment for producing the optical fiber drop cable of the present invention. Although the process performed by the manufacturing line shown in FIG. 3 is one embodiment for producing the optical fiber drop cable of the present invention, the drop cable of the present invention can be produced by other techniques and mechanisms. The primary steps used to produce the optical fiber drop cable of the present invention are shown in FIG. 4. However, these steps may also be altered to produce the drop cable of the present invention.

In accordance with the embodiment of FIG. 4, the optical fibers 2 (FIGS. 1 and 2) are secured within the rubber ribbons 7 and 8 (FIGS. 1 and 2), also referred to herein as tape and layers. This step is represented by block 31. As stated above, at some stage during the manufacturing process, a water blocking powder or grease is applied to the optical fibers (not shown). The rubber ribbons 7 and 8 having the fibers 2 secured between them are then secured within the ribbon supporting strength members 5 and 6 (FIGS. 1 and 2), as indicated by block 32. The outer edges 9 and 11 (FIGS. 1 and 2) of the ribbon supporting strength members 5 and 6 are then bonded together, as indicated by block 33.

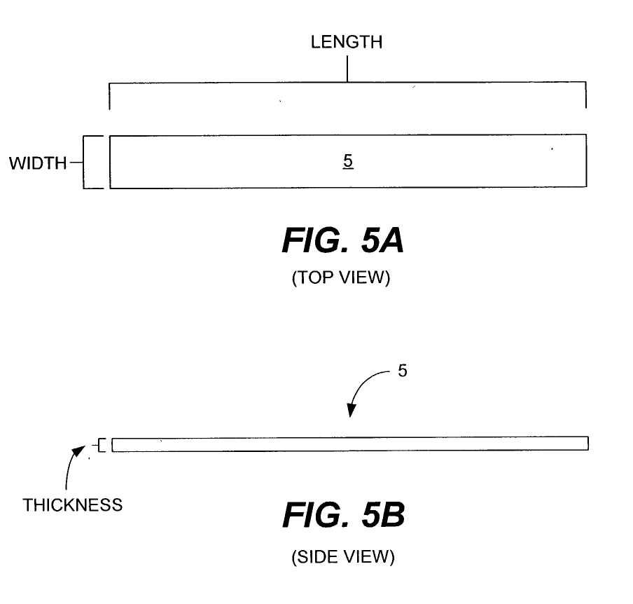

The outer edges may be bonded together in a plurality of ways, such as by glue bonding, heat bonding, ultrasonic bonding and solvent bonding, for example. Also, it should be noted that the present invention is not limited to any particular material for the strength supporting ribbons. The ribbons should be flat, made of a dielectric material and non-elongating. The strapping material used for packaging mentioned above is suitable because it possesses all of these qualities and is very inexpensive. Other materials, such as a Kevlar ribbon, could also be used. However, because Kevlar is relatively expensive, it is preferable to use less costly materials. Also, it is not necessary that rubber layers be used for cushioning the optical fibers between the strength supporting ribbons. A variety of materials are suitable for this purpose. The term “ribbon” has been used herein to indicate shape, i.e., a very high width-to-thickness ratio and a very high length-to-width ratio. To clarify this point, FIG. 5A illustrates a top view of a section of ribbon and FIG. 5B illustrates a side view of the section of ribbon shown in FIG. 5A.

In the top view of FIG. 5A, it can be seen that the length of the upper strength supporting ribbon 5 is larger that the width of the ribbon 5, which is typical for what is commonly referred to as a ribbon. In the side view of FIG. 5B it can be seen that the width of the ribbon 5 shown in FIG. 5A is significantly greater than the thickness of the ribbon, which is also typical of what is commonly referred to as a ribbon. Of course, the present invention is not limited to any particular length-to-width or width-to-thickness ratios for these ribbon or ribbon-like structures.

As can be seen from the embodiments described above, a relatively inexpensive, high quality optical fiber drop cable is provided that has sufficient tensile strength to be used as a drop cable and that can be easily and inexpensively manufactured. Furthermore, ribbons are currently available that are suitable for use as the strength supporting members that function as the outer jacket of the drop cable of the present invention. Thus, materials and manufacturing equipment currently exist that will enable an optical fiber drop cable in accordance with the present invention to be quickly and inexpensively produced. Another benefit of the optical fiber drop cable of the present invention is that the strength supporting ribbons can easily be cut using standard shears. This facilitates the tasks of connecting the optical fibers to the appropriate connectors at the pedestal and at the network interface unit mounted on the side of the house.

It should be noted that the present invention has been described with reference to particular embodiments. However, as will be understood by persons skilled in the art in view of the discussion provided herein, the present invention is not limited to the particular embodiments described herein. Those skilled in the art will understand, in view of the description provided herein, that modifications may be made to the embodiments described herein that are within the scope of the present invention.

What is claimed is:

1. An optical fiber drop cable for carrying one or more optical fibers from a curb to a customer premises, the optical fiber drop cable comprising:
first and second ribbon-like longitudinal support members disposed one atop the other and having one or more optical fibers disposed between the first and second ribbon-like longitudinal support members in a longitudinal direction of the first and second ribbon-like longitudinal support members, the first and second ribbon-like longitudinal support members each having first and second edges and inner and outer surfaces, the first edge of the first ribbon-like longitudinal support member being secured to the first edge of the second ribbon-like longitudinal support member, the second edge of the first ribbon-like longitudinal support member being secured to the second edge of the second ribbon-like longitudinal support member, said one or more optical fibers and said first and second ribbon-like longitudinal support members having longitudinal axes that are generally aligned.

2. The optical fiber drop cable of claim 1, further comprising:
a first longitudinal cushion layer having a first surface, a second surface, a first side and a second side, the first surface of the first longitudinal cushion layer being adjacent the inner surface of the first ribbon-like longitudinal support member, the second surface of the first longitudinal cushion layer being adjacent said one or more optical fibers; and
a second longitudinal cushion layer having a first surface, a second surface, a first side and a second side, the first surface of the first longitudinal cushion layer being adjacent the inner surface of the second ribbon-like longitudinal support member, the second surface of the second longitudinal cushion layer being adjacent said one or more optical fibers, the first and second longitudinal cushion layers having longitudinal axes that are generally aligned with the longitudinal axes of said one or more optical fibers and of said first and second ribbon-like longitudinal members.

3. The optical fiber drop cable of claim 2, further comprising:
a water proofing agent disposed on at least part of said one or more optical fibers.

4. The optical fiber drop cable of claim 1, wherein the first edges of the first and second ribbon-like longitudinal support members and the second edges of the first and second ribbon-like longitudinal support members are secured together by glue bonding.

5. The optical fiber drop cable of claim 1, wherein the first edges of the first and second ribbon-like longitudinal support members and the second edges of the first and second ribbon-like longitudinal support members are secured together by heat bonding.

6. The optical fiber drop cable of claim 1, wherein the first edges of the first and second ribbon-like longitudinal support members and the second edges of the first and second ribbon-like longitudinal support members are secured together by ultrasonic bonding.

7. The optical fiber drop cable of claim 1, wherein the first edges of the first and second ribbon-like longitudinal support members and the second edges of the first and second ribbon-like longitudinal support members are secured together by solvent bonding.

8. The optical fiber drop cable of claim 1, wherein the first and second ribbon-like longitudinal support members are plastic straps.

9. The optical fiber drop cable of claim 2, wherein the first and second longitudinal cushion layers are comprised of rubber.

10. A method for manufacturing an optical fiber drop cable for carrying one or more optical fibers from a curb to a customer premises, the method comprising the steps, of:
securing one or more optical fibers between first and second ribbon-like longitudinal support members disposed one atop the other, said one or more optical fibers being disposed between the first and second ribbon-like longitudinal support members in a longitudinal direction of the first and second ribbon-like longitudinal support members, the first and second ribbon-like longitudinal support members each having first and second edges and inner and outer surfaces;
securing the first edge of the first ribbon-like longitudinal support member to the first edge of the second ribbon-like longitudinal support member and securing the second edge of the first ribbon-like longitudinal support member to the second edge of the second ribbon-like longitudinal support member, said one or more optical fibers and said first and second ribbon-like longitudinal support members having longitudinal axes that are generally aligned when said one or more optical fibers are secured within the first and second ribbon-like longitudinal support members.

11. The method of claim 10 further comprising the steps of:
prior to securing said one or more optical fibers between said first and second ribbon-like longitudinal members, placing a first longitudinal cushion layer in contact with an inner surface of said first ribbon-like longitudinal support member, the first longitudinal cushion layer having a first surface, a second surface, a first side and a second side, the first surface of the first longitudinal cushion layer being placed in contact with the inner surface of the first ribbon-like longitudinal support member, the second surface of the first longitudinal cushion layer being adjacent said one or more optical fibers; and
prior to securing said one or more optical fibers between said first and second ribbon-like longitudinal members, placing a second longitudinal cushion layer in contact with an inner surface of said second ribbon-like longitudinal support member, the second longitudinal cushion layer having a first surface, a second surface, a first side and a second side, the first surface of the second longitudinal cushion layer being placed in contact with the inner surface of the second ribbon-like longitudinal support member, the second surface of the first longitudinal cushion layer being adjacent said one or more optical fibers, the first and second longitudinal cushion layers protecting said one or more optical fibers.

12. The method of claim 11, further comprising the step of:
placing a water proofing agent on at least part of said one or more optical fibers prior to securing the first and second edges of the first and second ribbon-like support members together.

13. The method of claim 10, wherein the step of securing the first edges of the first and second ribbon-like longitudinal support members together and the second edges of the first and second ribbon-like longitudinal support members together is performed by glue bonding the first edges and the second edges of the first and second ribbon-like longitudinal support members together.

14. The method of claim 10, wherein the step of securing the first edges of the first and second ribbon-like longitudinal support members together and the second edges of the first and second ribbon-like longitudinal support members together is performed by heat bonding the first edges and the second edges of the first and second ribbon-like longitudinal support members together.

15. The method of claim 10, wherein the step of securing the first edges of the first and second ribbon-like longitudinal support members and the second edges of the first and second ribbon-like longitudinal support members is performed by ultrasonic bonding the first edges and the second edges of the first and second ribbon-like longitudinal support members together.

16. The method of claim 10, wherein the step of securing the first edges of the first and second ribbon-like longitudinal support members together and the second edges of the first and second ribbon-like longitudinal support members together is performed by solvent bonding the first edges and the second edges of the first and second ribbon-like longitudinal support members together.

17. The method of claim 10, wherein the first and second ribbon-like longitudinal support members are plastic straps.

18. The method of claim 11, wherein the first and second longitudinal cushion layers are comprised of rubber.
